(19) United States
(12) Patent Application Publication
(10) Pub. No.: US 2005/0005236 A1
(43) Pub. Date: Jan. 6, 2005

(54) Method of displaying a document

(76) Inventors: Hans-Frederick Brown, Montreal (CA); Sylvio Drouin, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/836,622

(22) Filed: May 3, 2004

Related U.S. Application Data
(60) Provisional application No. 60/466,773, filed on May 1, 2003.

(51) Int. Cl. G06F 17/21

(52) U.S. Cl. 715/520; 715/539; 715/517; 715/518; 715/529

(57) ABSTRACT

The present invention relates to methods of displaying a document in a graphical user interface wherein a redundancy of information comprised within overlapping views of the document is exploited to reduce a number of panes displayed. The present invention also provides a method of displaying a document in a graphical user interface wherein users operating in a view of the document are provided with an automatic generation and positioning of views of the document comprising complementary information. The present invention also provides a method of generating a representation of at least two parts of a document on a scroll bar whereby a relative positioning of the at least two parts is clearly indicated.

The present application claims priority of U.S. provisional patent application No. 60/466,773 filed May 1^{st}, 2003.

### BACKGROUND OF THE INVENTION

(a) Field of the Invention

This invention relates to interactive user interfaces within video display terminal screens in computing systems, generally referred to as graphical user interfaces. The invention more particularly relates to improvements in the use of panes in an application window of a graphical user interface and provides control for creating, merging, and scrolling within, panes comprised in a window.

(b) Description of Prior Art

Graphical user interfaces are well known, and can be thought of as end-user environments in which information is displayed graphically. A common feature of such interfaces is the capability of displaying a multitude of views simultaneously, and allowing a user to move back and forth between those views, thereby making it possible to perform different tasks in an efficient manner. Such views are usually displayed within panes, wherein each pane is a portion of a window associated with a particular computer application. As such, a plurality of panes can be displayed within a single window.

Although the management of windows and panes in computing systems has become increasingly sophisticated, current graphical user interfaces bear several weaknesses regarding the way in which panes within windows are created and merged.

U.S. Pat. No. 5,390,295, entitled “METHOD AND APPARATUS FOR PROPORTIONALLY DISPLAYING WINDOWS ON A COMPUTER DISPLAY SCREEN”, describes a method and an apparatus for displaying each of a plurality of windows on a screen according to its active periods. More particularly, windows that are active for longer periods of time are displayed more distinctively than others. Although such a method is useful for clearing overcrowded screens by graphically establishing a priority among a plurality of windows, it lacks in efficiency as time is its only priority criterion. In the case where two windows presenting substantially similar information are active during substantial periods of time, both windows gain priority over other windows, regardless of their redundancy.

U.S. Pat. No. 5,714,971, titled “SPLIT BAR AND INPUT/OUTPUT WINDOW CONTROL ICONS FOR INTERACTIVE USER INTERFACE”, describes the provision of an icon added to a standard scroll bar through which a user may invoke a routine to create a new pane on the screen, wherein the newly created pane presents a user-selected object. Although such a method is useful for requesting a more convenient view of a selected object, it does not provide means for accessing other objects related to a selected one whereby an efficiency with which documents are navigated would be improved.

U.S. Pat. No. 4,890,098, titled “FLEXIBLE WINDOW MANAGEMENT ON A COMPUTER DISPLAY”, describes a method of managing windows in a display system wherein a user is provided with means to mark an area on the display to define dimensions and contents of a resized window. Contents within the enclosed area are incorporated into the resized window without causing other windows to be modified. The marked area may span several windows such that contents of the several windows enclosed within the area may be incorporated into the resized window. Although such a feature is useful for reducing a number of windows displayed on an overcrowded screen, it does not provide means for automatically merging two windows presenting overlapping views.

U.S. Pat. No. 6,310,631, titled “USER INTERFACE CONTROL FOR CREATING SPLIT PANES IN A SINGLE WINDOW”, describes a method for creating and sizing panes within a window of a display screen through grab handles positioned on the borders of the panes. Although such an invention is useful for splitting a pane and displaying multiple views of a same document, it does not provide means for automatically splitting a pane. Furthermore, it does not provide a method for determining a content of the two views presented by the panes resulting from the split, whereby an efficiency with which documents are navigated would be improved.

### SUMMARY OF THE INVENTION

It would be desirable to be provided with a method for automatically merging two views of a same document when an overlap of the two views is detected, whereby a number of views displayed on a screen would be conveniently reduced without compromising an amount of information provided to a user.

It would also be desirable to be provided with a method for automatically collapsing a first view when its content is identified as substantially comprised in a second view, whereby a number of views displayed on a screen would be conveniently reduced without compromising an amount of information provided to a user.

It would also be desirable to be provided with a method for automatically displaying a second view of a document comprising an object related to an object of interest comprised in a first view of the document, whereby two complementary views of the document would be readily available.

It would also be desirable to be provided with a scroll bar for managing several views of a same document, whereby a relative position of portions of the document presented by the several views would be conveyed.

In accordance with the present invention, there is provided a method of displaying a document in a graphical user interface comprising: displaying in a scrollable manner a first part of the document; displaying a second part of the document; detecting an overlap between the first part and the second part of the document that results from a scrolling of the first part in response to a scroll control input; and displaying in a scrollable manner a consolidated view of the first part and the second part of the document in response to the detecting.

In accordance with one embodiment of the present invention, wherein the consolidated view results from merging a display of the first part, and a display of the second part.

In accordance with one embodiment of the present invention, the method further comprises removing the second part displayed, wherein the first part displayed comprises the second part displayed.

In accordance with the present invention, there is provided a method of displaying a document in a graphical user interface comprising: displaying in a scrollable manner a first part of the document; displaying a second part of the document; detecting an overlap between the first part and the second part of the document that results from a scrolling of the first part in response to a scroll control input, wherein the first part is comprised in the second part; and removing the second part displayed in response to the detecting.

In accordance with one embodiment of the present invention, the displaying a second part comprises displaying the second part in a scrollable manner.

In accordance with one embodiment of the present invention, the displaying in a scrollable manner comprises displaying the first part of the document in a first pane, and the displaying a second part comprises displaying the second part in a second pane.

In accordance with the present invention, there is provided a method of displaying a document in a graphical user interface, comprising: displaying in a scrollable manner the document so as to view any one of a plurality of objects in a first part; selecting an object of interest from the plurality in the first part; locating a target object of the plurality related to the object of interest, and not comprised in the first part; identifying an available display surface that does not overlap a display surface occupied by the object of interest; and displaying the document in the available display surface so as to view a second part of the document, wherein the second part comprises at least the target object, whereby the object of interest and the target object are displayed simultaneously.

In accordance with one embodiment of the present invention, the displaying in a scrollable manner comprises displaying the first part of the document in a first pane of an application window, and the displaying the document comprises displaying the second part of the document in a second pane of the application window.

In accordance with one embodiment of the present invention, the method further comprises reducing a dimension of the first pane, whereby a dimension of the application window is maintained.

In accordance with one embodiment of the present invention, the method further comprises reducing a dimension of the first pane to provide an adjusted first pane, whereby the dimension of the first pane is equal to a dimension of a surface occupied by the adjusted first pane and the second pane.

In accordance with one embodiment of the present invention, the target object is displayed at a center of the second pane.

In accordance with one embodiment of the present invention, the document presents a node-link structure including at least two nodes and at least one link, each of the at least one link relating at least two of the at least two nodes, the object of interest is a link of interest of the at least one link, and the target object is a target node related through the link of interest.

In accordance with one embodiment of the present invention, the method further comprises locating a second target node related through the link of interest to the first target node and not displayed in the first pane, and displaying the second target node in the first pane.

In accordance with one embodiment of the invention, the second target node is displayed at a center of the first pane.

In accordance with one embodiment of the invention, the method further comprises providing for the link of interest a visual indication, whereby the link of interest is visually distinguished from other links of the plurality of links.

In accordance with one embodiment of the invention, the method further comprises providing for the target object a visual indication, whereby the target object is visually distinguished from other objects.

In accordance with one embodiment of the invention, the method further comprises providing for the second target node a visual indication, whereby the second target node is visually distinguished from other nodes of the plurality of nodes.

In accordance with one embodiment of the invention, the method further comprises displaying an external link relating a segment of the link of interest displayed in the first pane and a segment of the link of interest displayed in the second pane.

In accordance with one embodiment of the invention, the method further comprises providing for the external link a visual indication, whereby the external link is visually distinguished from the at least one link.

In accordance with the present invention, there is provided a method of generating a representation of a position of at least two parts of a document on a scroll bar, comprising: displaying in a first pane a first part of the document and in a second pane, a second part of the document; displaying the scroll bar; locating a first position of the first part in the document, and a second position of the second part in the document; determining a first slider position according to the first position and a length of the scroll bar, and a second slider position according to the second position and the length of the scroll bar; displaying the first slider according to the first slider position in the scroll bar; and displaying the second slider according to the second slider position in the scroll bar.

In accordance with one embodiment of the invention, the method further comprises determining a first slider length according to a size of the document, a size of the first part, and the length of the scroll bar, and determining a second slider length according to a size of the document, a size of the second part, and the length of the scroll bar, wherein the displaying the first slider comprises displaying the first slider according to the first slider length, and the displaying the second slider comprises displaying the second slider according to the second slider length.

In accordance with one embodiment of the invention, the method further comprises providing a visual indication for distinguishing the first slider from the second slider.

In accordance with one embodiment of the invention, the method further comprises scrolling through the document in the first pane using the first slider.

In accordance with one embodiment of the invention, the method further comprises scrolling through the document in the second pane using the second slider.

In accordance with one embodiment of the invention, the method further comprises modifying a length of the scroll bar, determining a new first slider position, a new second slider position, a new first slider length, and a new second slider length according to the modifying, and displaying the first slider according to the new first slider position and the new first slider length, and the second slider according to the new second slider position and the new second slider length in the scroll bar.

In accordance with the present invention, there is provided a computer program product for displaying a document in a graphical user interface comprising a computer usable storage medium having computer readable program code means embodied in the medium, the computer readable program code means comprising: computer readable program code means for displaying in a scrollable manner a first part of the document; computer readable program code means for displaying a second part of the document; computer readable program code means for detecting an overlap between the first part and the second part of the document that results from a scrolling of the first part in response to a scroll control input; and computer readable program code means for displaying in a scrollable manner a consolidated view of the first part and the second part of the document in response to the detecting.

In accordance with one embodiment of the invention, the computer program product further comprises computer readable program code means for removing the second part displayed, wherein the first part displayed comprises the second part displayed.

In accordance with the present invention, there is provided a computer program product for displaying a document in a graphical user interface comprising a computer usable storage medium having computer readable program code means embodied in the medium, the computer readable program code means comprising: computer readable program code means for displaying in a scrollable manner a first part of the document; computer readable program code means for displaying a second part of the document; computer readable program code means for detecting an overlap between the first part and the second part of the document that results from a scrolling of the first part in response to a scroll control input, wherein the first part is comprised in the second part; and computer readable program code means for removing the second part displayed in response to the detecting.

In accordance with one embodiment of the present invention, the computer readable program code means for displaying a second part comprises computer readable program code means for displaying the second part in a scrollable manner.

In accordance with one embodiment of the present invention, the computer readable program code means for displaying in a scrollable manner comprises computer readable program code means for displaying the first part of the document in a first pane, and the computer readable program code means for displaying a second part comprises computer readable program code means for displaying the second part in a second pane.

In accordance with the present invention, there is provided a computer program product for displaying a document in a graphical user interface comprising: computer readable program code means for displaying in a scrollable manner the document so as to view any one of a plurality of objects in a first part; computer readable program code means for selecting an object of interest from the plurality in the first part; computer readable program code means for locating a target object of the plurality related to the object of interest, and not comprised in the first part; computer readable program code means for identifying an available display surface that does not overlap a display surface occupied by the object of interest; and computer readable program code means for displaying the document in the available display surface so as to view a second part of the document, wherein the second part comprises at least the target object, whereby the object of interest and the target object are displayed simultaneously.

In accordance with one embodiment of the present invention, the computer readable program code means for displaying in a scrollable manner comprises computer readable program code means for displaying the first part of the document in a first pane of an application window, and the computer readable program code means for displaying the document comprises computer readable program code means for displaying the second part of the document in a second pane of the application window.

In accordance with one embodiment of the invention, the computer program product further comprises computer readable program code means for reducing a dimension of the first pane, whereby a dimension of the application window is maintained.

In accordance with one embodiment of the invention, the computer program product further comprises computer readable program code means for reducing a dimension of the first pane to provide an adjusted first pane, whereby the dimension of the first pane is equal to a dimension of a surface occupied by the adjusted first pane and the second pane.

In accordance with one embodiment of the invention, the target object is displayed at a center of the second pane.

In accordance with one embodiment of the invention, the document presents a node-link structure including at least two nodes and at least one link, each of the at least one link relating at least two of the at least two nodes, the object of interest is a link of interest of the at least one link, and the target object is a target node related through the link of interest.

In accordance with one embodiment of the invention, the computer program product further comprises computer readable program code means for locating a second target node related through the link of interest to the first target node and not displayed in the first pane, and computer readable program code means for displaying the second target node in the first pane.

In accordance with one embodiment of the invention, the second target node is displayed at a center of the first pane.

In accordance with one embodiment of the invention the computer program product further comprises computer readable program code means for providing for the link of interest a visual indication, whereby the link of interest is visually distinguished from other links of the plurality of links.

In accordance with one embodiment of the invention, the computer program product further comprises computer readable program code means for providing for the target object a visual indication, whereby the target object is visually distinguished from other objects.

In accordance with one embodiment of the invention, the computer program product further comprises computer readable program code means for providing for the second target node a visual indication, whereby the second target node is visually distinguished from other nodes of the plurality of nodes.

In accordance with one embodiment of the invention, the computer program product further comprises computer readable program code means for displaying an external link relating a segment of the link of interest displayed in the first pane and a segment of the link of interest displayed in the second pane.

In accordance with one embodiment of the invention, the computer program product further comprises computer readable program code means for providing for the external link a visual indication, whereby the external link is visually distinguished from the at least one link.

In accordance with the present invention, there is provided a computer program product for generating a representation of a position of at least two parts of a document on a scroll bar comprising a computer usable storage medium having computer readable program code means embodied in the medium, the computer readable program code means comprising: computer readable program code means for displaying in a first pane a first part of the document and in a second pane, a second part of the document; computer readable program code means for displaying the scroll bar; computer readable program code means for locating a first position of the first part in the document, and a second position of the second part in the document; computer readable program code means for determining a first slider position according to the first position and a length of the scroll bar, and a second slider position according to the second position and the length of the scroll bar; computer readable program code means for displaying the first slider according to the first slider position in the scroll bar; and computer readable program code means for displaying the second slider according to the second slider position in the scroll bar.

In accordance with the present invention, the computer program product further comprises computer readable program code means for determining a first slider length according to a size of the document, a size of the first part, and the length of the scroll bar, and computer readable program code means for determining a second slider length according to a size of the document, a size of the second part, and the length of the scroll bar, wherein the computer readable program code means for displaying the first slider comprises computer readable program code means for displaying the first slider according to the first slider length, and the computer readable program code means for displaying the second slider comprises computer readable program code means for displaying the second slider according to the second slider length.

In accordance with the present invention, the computer program product further comprises computer readable program code means for providing a visual indication for distinguishing the first slider from the second slider.

In accordance with the present invention, the computer program product further comprises computer readable program code means for scrolling through the document in the first pane using the first slider.

In accordance with the present invention, the computer program product further comprises computer readable program code means for scrolling through the document in the second pane using the second slider.

In accordance with the present invention, the computer program product further comprises computer readable program code means for modifying a length of the scroll bar, computer readable program code means for determining a new first slider position, a new second slider position, a new first slider length, and new second slider length according to the modifying, and computer readable program code means for displaying the first slider according to the new first slider position and the new first slider length, and the second slider according to the new second slider position and the new second slider length in the scroll bar.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates an application window comprising two panes presenting different views of a same document;

FIG. 2 illustrates an application window comprising two panes presenting overlapping views of a same document;

FIG. 3 illustrates an application window comprising a pane presenting a view of a document resulting from merging two panes that present overlapping views of the document according to the present invention;

FIG. 4 illustrates an application window comprising two panes presenting different views of a same document, wherein scrolling is performed in one of the views;

FIG. 5 illustrates an application window comprising a first pane presenting a first view of a document, and a second pane presenting a second view of the document, wherein the second view is comprised in the first view;

FIG. 6 illustrates an application window comprising a single pane after having its second pane collapsed according to the present invention;

FIG. 7 illustrates an application window comprising a pane presenting a view of a document, wherein the view comprises a first object, but not a second object related to the first one;

FIG. 8 illustrates an application window comprising a first pane presenting a first view of a document comprising a first object, and a second pane presenting a second view of the document comprising a second object related to the first one, wherein the display of the second pane was initiated by a selection of the first object, and performed according to the present invention;

FIG. 9 illustrates an application window comprising two panes resulting from a division of a previous pane, wherein a dimension of a surface occupied by the two panes is equal to that of a surface that was occupied by the previous pane;

FIG. 10 illustrates an application window comprising a pane presenting a view of a node-link structure, wherein the view comprises a first node of interest, but not a second node related to the node of interest through a link;

FIG. 11 illustrates an application window comprising a first pane presenting a first view of a node-link structure comprising a first node, and a second pane presenting a second view of the structure comprising a second node related to the first one through a link, wherein the display of the second pane is initiated by a selection of the first node, and performed according to the present invention;

FIG. 12 illustrates an application window comprising a pane presenting a view of a node-link structure, wherein the view comprises a link of interest, but not the nodes to which it is associated;

FIG. 13 illustrates an application window comprising a first pane presenting a first view of a node-link structure comprising a first node, and a second pane presenting a second view of the structure comprising a second node related to the first one through a link, wherein the display of the second pane is initiated by a selection of the link, and performed according to the present invention; and

FIG. 14 illustrates an application window comprising two panes presenting different views of a same document wherein a scroll bar of one of the panes comprises an additional slider corresponding to a position of the view presented in the other pane within the document.

### DETAILED DESCRIPTION OF THE INVENTION

As indicated above, a common feature in graphical user interface systems is the capability to divide a single window into multiple panes, each of which may present separate or related information. When dealing with different parts of a same document, users often require that several of those parts be readily available on a screen. For each of those several parts, users typically create an additional pane, and scroll through the document until a corresponding view is displayed. Once the panes are created and set, the user may move back and forth between the complementary views in order to accomplish a given task. However, as windows become overcrowded, it becomes increasingly difficult to locate a view of interest among those presented by the various panes, and users are compelled to close some of the least significant ones in order to alleviate their searches.

The present invention provides means for automatically reducing a number of panes comprised in a window without compromising an amount of information presented to the user.

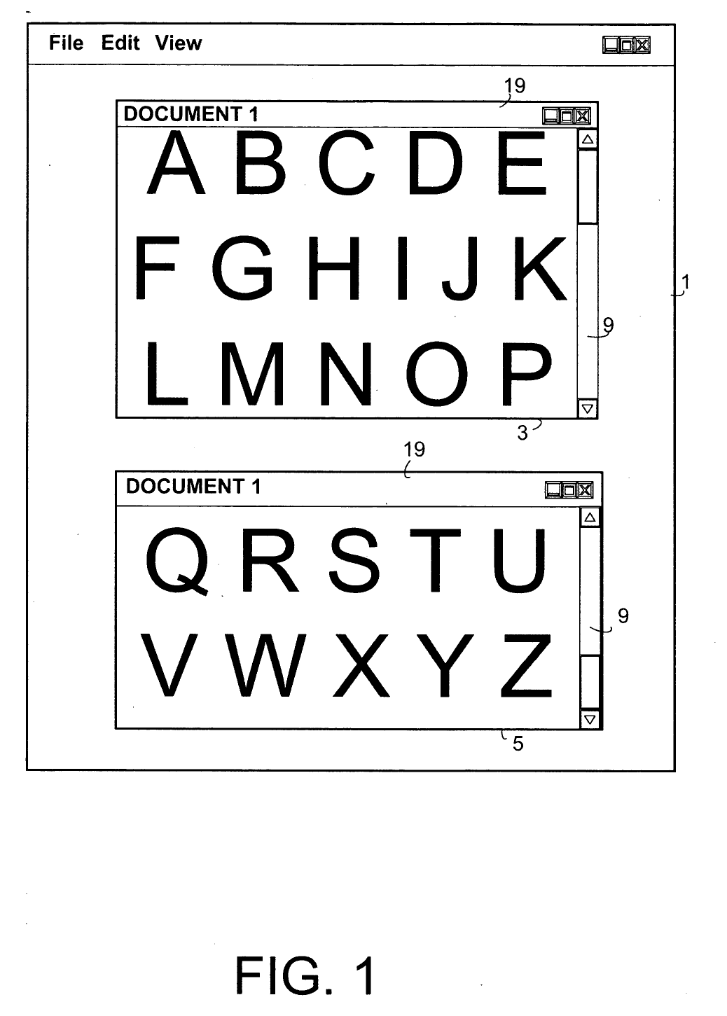

FIG. 1 illustrates an application window 1, comprising a first pane 3 and a second pane 5, each pane displaying different views of a same document. In the preferred embodiment, each of the panes 3 and 5 comprises a toolbar 19 and a scroll bar 9, the scroll bar allowing a user to scroll through the document within a corresponding pane.

The panes 3 and 5 serve the purpose of presenting two different views, such that a user may contemplate two different parts of the document simultaneously, or, at the very least, be able to access those views readily. However, while scrolling through the document within either one of the panes 3 and 5, or both, the views presented therein may overlap. The present invention exploits a redundancy of information comprised within the overlapping region to reduce a number of panes displayed in a window.

In order for the method of the present invention to be applied, a height and width need to be recorded for a display screen, each window displayed thereon, and each pane comprised therein. Furthermore, for each pane, a corresponding document identifier, and a location of a corresponding view presented within a corresponding document need to be recorded. The parameters are maintained and analyzed at the occurrence of every relevant event in order to determine whether two of the displayed panes should be merged.

For particular embodiments, the term “relevant event” shall be taken to include, but not be limited to, a creation of a new window, a resizing of a window, a creation of a new pane, a resizing of a pane, and a scrolling movement within a pane.

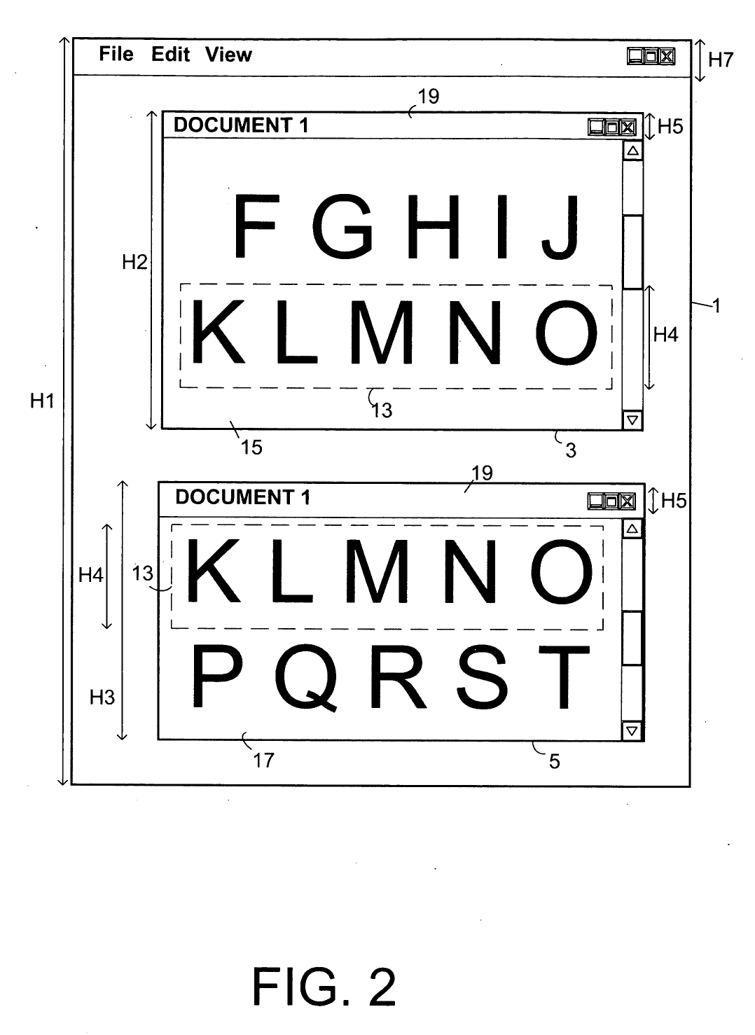

Referring to FIG. 2, there is illustrated the window 1 of height H1, having a toolbar of height H7, and comprising the panes 3 and 5, of height H2 and H3 respectively, wherein toolbars 19 are of height H5, and a lower part of a. view 15 presented in the pane 3, overlaps with an upper part of a view 17 presented in the pane 5. More specifically, a region 13 of height H4 of the document is simultaneously displayed in the panes 3 and 5.

According to the invention, if (H2+H3−H4−H5)<(H1−H7), the panes 3 and 5 are merged. As a result, the user is able to contemplate the views 13 and 15 simultaneously in a single pane, which alleviates the complexity of pane management.

In a preferred embodiment, if (H2+H3−H4−H5)>(H1−H7), but (H2+H3−H4−H5)=H6, wherein (H6+H7) is lesser than a height of a display area of the screen, it would be preferable for the window 1 to be extended such that H1=H6, in order for the panes 3 and 5 to be merged into a single pane. If however, (H6+H7) is greater than the height of the display screen, the height H1 of the window 1 is maintained, and the merger is not performed.

In an alternate embodiment, if (H2+H3−H4−H5)>(H1−H7), the height H1 of the window 1 is maintained, and the merger is not performed, in order to prevent the window 1 from hiding, or being hidden by other windows.

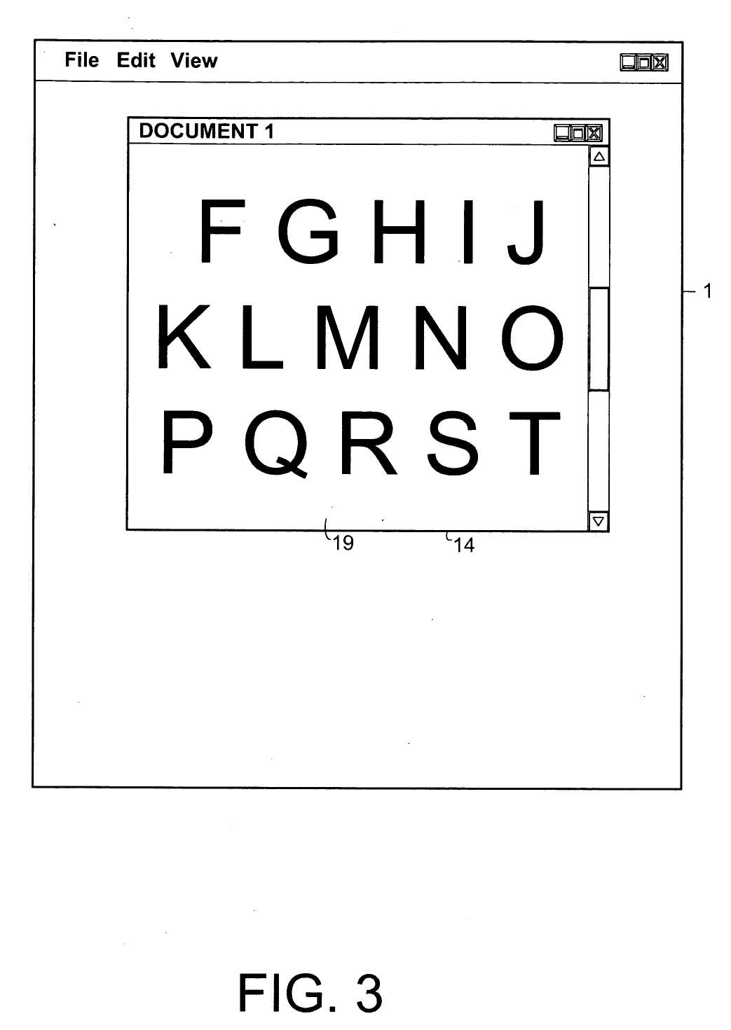

In the case depicted in FIG. 2, (H2+H3−H4−H5)<(H1−H7). Consequently, the panes 3 and 5 are merged, as shown in FIG. 3, into a pane 14 presenting a consolidated view 19 of the views 15 and 17. As a result of the merger, the number of panes comprised in the window 1 is reduced, which, as mentioned herein above, alleviates the complexity of pane management.

In the preferred embodiment, the merger occurs only if the user maintains overlapping views for an amount of time that indicates his interest in contemplating both views. However, in another embodiment, the merger occurs as soon as the height requirements described herein above are met.

In one embodiment, overlapping views represent views that are in the vicinity of each other such that they may be displayed within a same pane.

In one embodiment, panes presenting overlapping views are not merged, and an automatic scrolling motion is performed in at least one of the panes in order to reduce or eliminate the occurrence of an overlap. Subsequently, any scrolling motion in one of the panes that would normally lead to an overlap is propagated through to the other panes, such that the overlap is minimized, or does not occur. In this embodiment, a consolidated view is defined as a combination of views where overlaps are prevented through the automatic scrolling mechanism.

Although within the context of the case illustrated in FIGS. 1-3, the present invention was described as dealing with two views, it may similarly deal with more than two views, wherein more than two panes would be merged.

Although within the context of the case illustrated in FIGS. 1-3, the present invention was described as dealing with surface heights, it may similarly deal with surface widths, wherein mergers would be achieved along a horizontal axis.

A simpler method of reducing a number of panes comprised in a window consists in automatically collapsing redundant panes. For the purposes of the following description, a “redundant pane” is defined as a pane presenting a view that is substantially comprised in a view presented by another pane.

In order for the method to be performed, a height, a width, a corresponding document identifier, and a location of a corresponding view presented within a corresponding document need to be recorded for each pane. The parameters are maintained and analyzed at the occurrence of every relevant event, in order to determine whether a pane should be collapsed.

For particular embodiments, the term “relevant event” shall be taken to include, but not be limited to, a creation of a new window, a resizing of a window, a creation of a new pane, a resizing of a pane, and a scrolling movement within a pane.

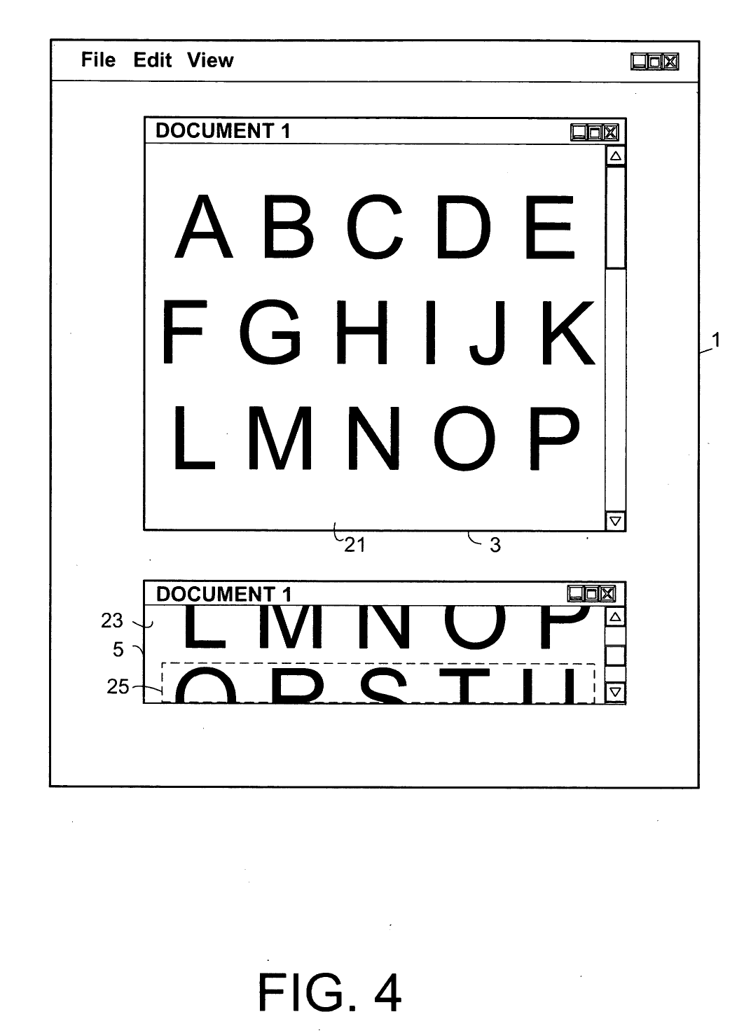

FIG. 4 illustrates the window 1, comprising the panes 3 and 5, each pane presenting a different view of the document. As the user scrolls up the document within the pane 5, a lower part of a view 21 presented by the pane 3 gradually overlaps an Lipper part of a view 23 presented by the pane 5. However, the pane 5 is not yet considered as redundant, since the view 23 provides information comprised within a region 25 that is not provided by the view 21. Therefore, if the pane 5 were to be collapsed at this point, there would be a loss of information.

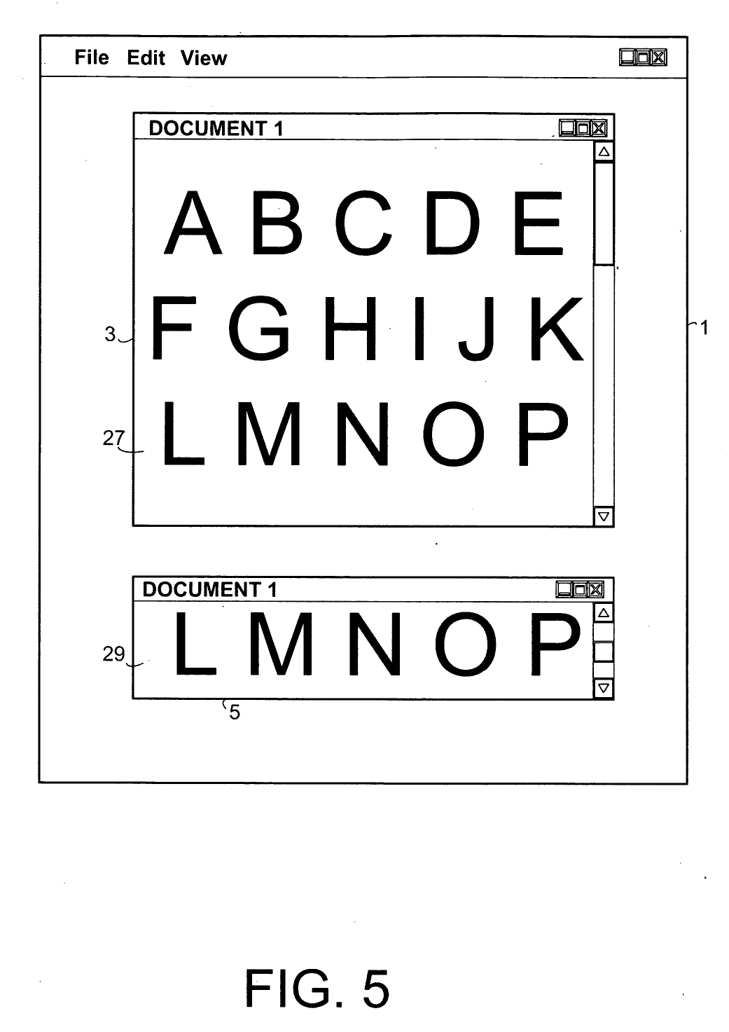

Referring to FIG. 5, there is shown the window 1 comprising the panes 3 and 5, each pane presenting a different view of the document. The overlap is more significant in this particular case as a view 27 presented by the pane 3 substantially comprises a view 29 presented by the pane 5. As a result, the latter is identified as redundant and collapsed.

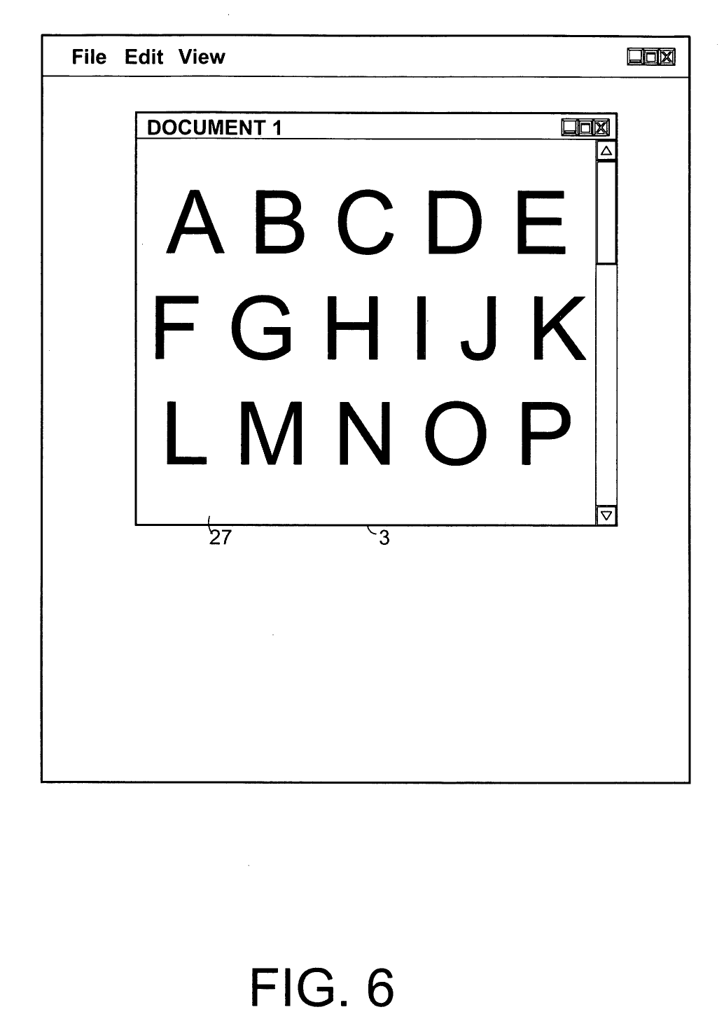

The resulting display is illustrated in FIG. 6. The number of panes comprised in the window 1 is automatically reduced without any loss of information, as the view 27 presented by the remaining pane 3 substantially comprises the view 29 that was presented by the pane 5 before it collapsed.

Although the panes 3 and 5 presented herein above are described as comprising a scroll bar, it suffices that one of the panes 3 and 5 provides a means for scrolling in order for the methods to be applicable.

According to those methods, in order to reduce a number of panes comprised in a window, at least two panes must have been previously created. As mentioned previously, the display of multiple panes within a window is useful to have different views readily available when working on different parts of a document. In order to achieve such a display, a user must explicitly request additional panes to be created, and scroll through the document within the new panes until a complementary set of views is presented. This method is clearly inefficient, especially when the document is lengthy and the user is unaware of its structure.

The present invention provides a means for automatically creating panes presenting complementary views of a same document according to a user's needs, wherein the document is saved as a combination of a list of pointers and a tree, each node of the tree representing a data object that may be accessed through one of the pointers. Data objects typically contain data, as well as pointers to their children.

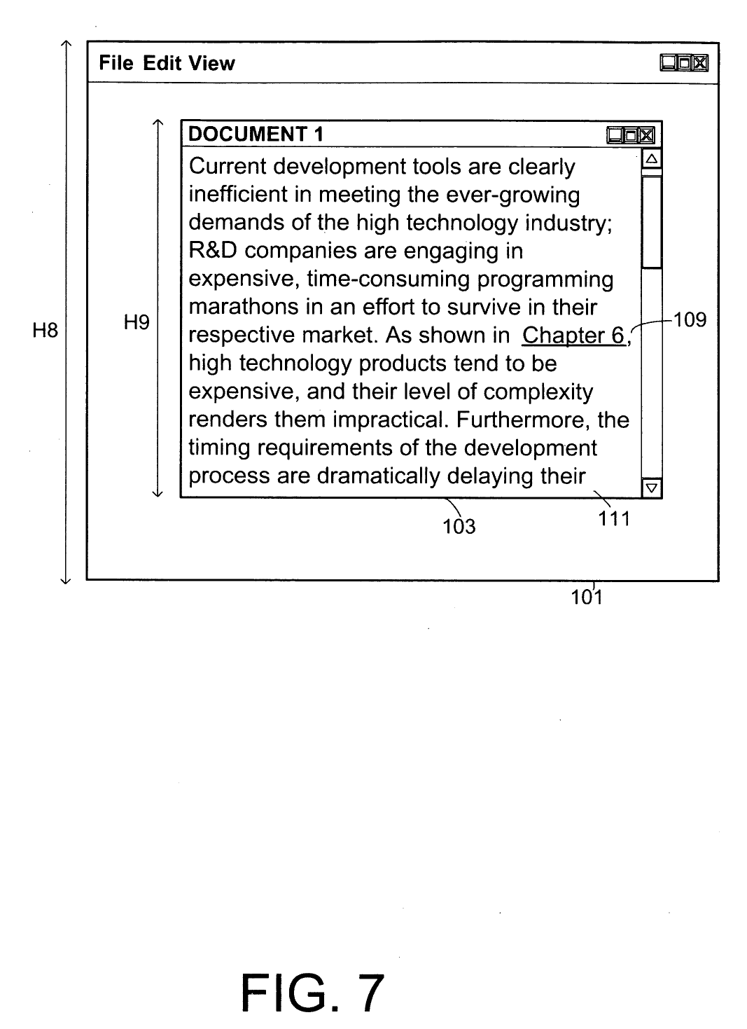

FIG. 7 illustrates an application window 101 of height H8 comprising a pane 103 of height H9, presenting a view 111 of a document. The view comprises a reference 109 that is visually distinguished from other data by an underline, and refers to data comprised in a data object of the document.

In one case, the reference 109 and the data it refers to may not be simultaneously displayable within the pane 103 due to their absolute coordinates within the document. In another case, they may be simultaneously displayable, but at the cost of substantially reducing their displayed contextual support and by the same token, their comprehensibility. However, in both of these cases, it would be convenient for a user to be automatically provided with two panes presenting complementary views of the document, a first of which comprises the reference 109, and the second, the corresponding data, wherein the reference 109 and the corresponding data could be readily placed into their respective contexts.

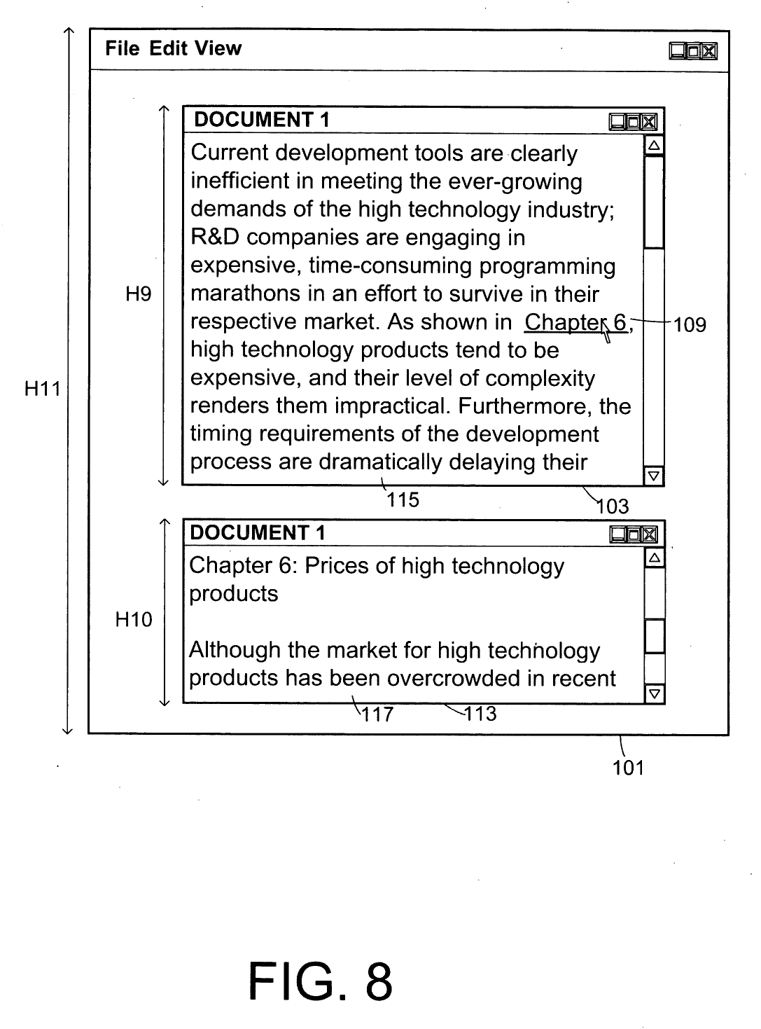

FIG. 8 illustrates the application window 101 comprising the pane 103, and a pane 113, presenting different views of the document. The pane 103 presents a view 115 comprising the reference 109, and the pane 113 presents a view 117 comprising the corresponding data.

Such a display of complementary views was achieved according to a method of the present invention, and requires a negligible amount of effort on behalf of the user. As a matter of fact, the latter is only required to select the reference 109 from the view 115 in order for the view 117 to be displayed. In the preferred embodiment, the user performs the selection by positioning a cursor on the reference 105, and pressing a user control.

Once the reference 109 is selected, its absolute coordinates within the document are calculated from its display coordinates, and used to search for a corresponding pointer in a list associated to the document. The located pointer allows for a data object of a tree associated to the document to be accessed, wherein the data object comprises, or points to other objects comprising the data corresponding to the reference 109. Consequently, the tree is traversed recursively from the data object indicated by the located pointer in order to extract the corresponding data as well as other data for the purpose of establishing a contextual support of the corresponding data. Finally, the pane 113 is created in order to present the view 117 comprising the corresponding data and their contextual support.

In the embodiment illustrated in FIG. 8, the pane 103 maintains its height, H9, and the pane 113 is assigned a height equal to H9, which is considered to be the minimal height required to display a substantial amount of information. As a result, the height occupied by the panes 103 and 113 is larger than the original height, H8, of the window 101, and the latter is expanded in order to accommodate the heights of its panes.

In the preferred embodiment, the pane 113 is assigned a dimension of D3, and a dimension of the pane 103 is reduced from D1 to D2, such that D2=(D1−D3), wherein D3 represents a minimal dimension required to display a substantial amount of information. As a result, a dimension of a surface occupied by the panes 103 and 113 is equal to that of a surface that was previously occupied by the pane 103. In the case where D1<(2*D3), the pane 103 is reduced to D3, the pane 113 is assigned a dimension equal to D3, and the dimension of the window 101 is expanded in order to accommodate a dimension of (2*D3). When D1 is reduced, the absolute coordinates of the reference 109 are accessed in order to verify whether the reference 109 is still displayed in the pane 103. In the case where the reference 109 is not displayed in the pane 103, a view of the document presented by the pane 103 is shifted such that the reference 109 becomes clearly displayed.

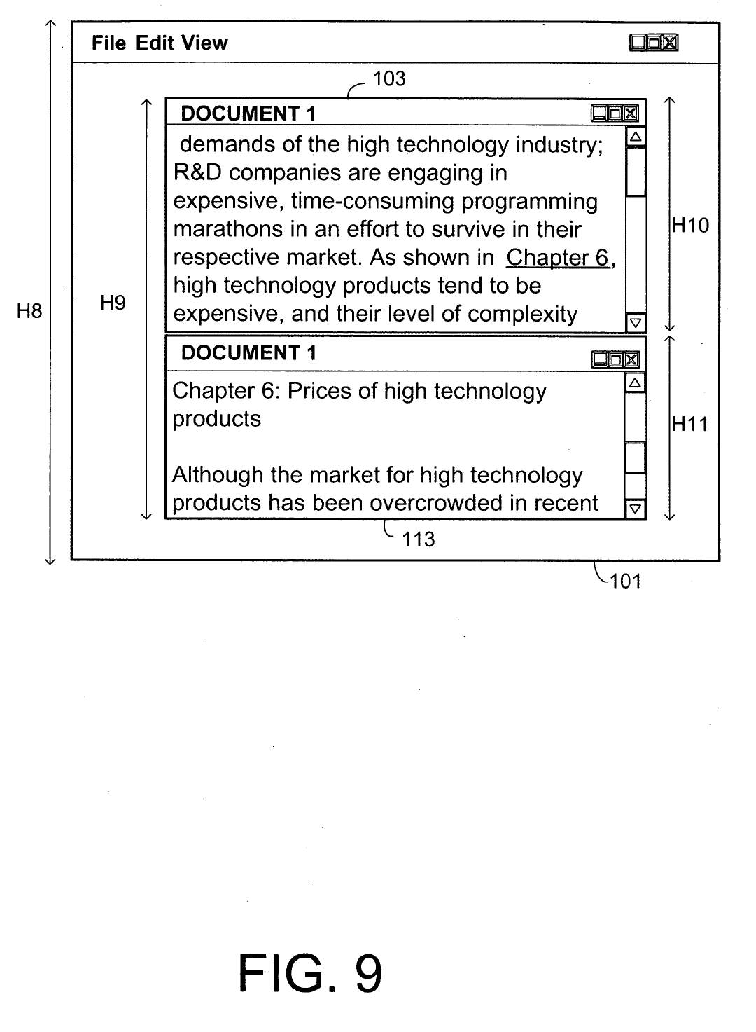

An example is illustrated in FIG. 9, wherein a minimal height required to display a substantial amount of information is H10, and as such, the pane 113 is assigned a height equal to H10. The height H8 of the pane 103 was reduced to H10, such that H9=H10+H11. It should be obvious for a person skilled in the art that the same calculations may be applied for a managing a width of the panes.

This method of displaying complimentary views of a same document is particularly useful for navigating through a complex node-link structure saved as a combination of a list of links and a list of nodes.

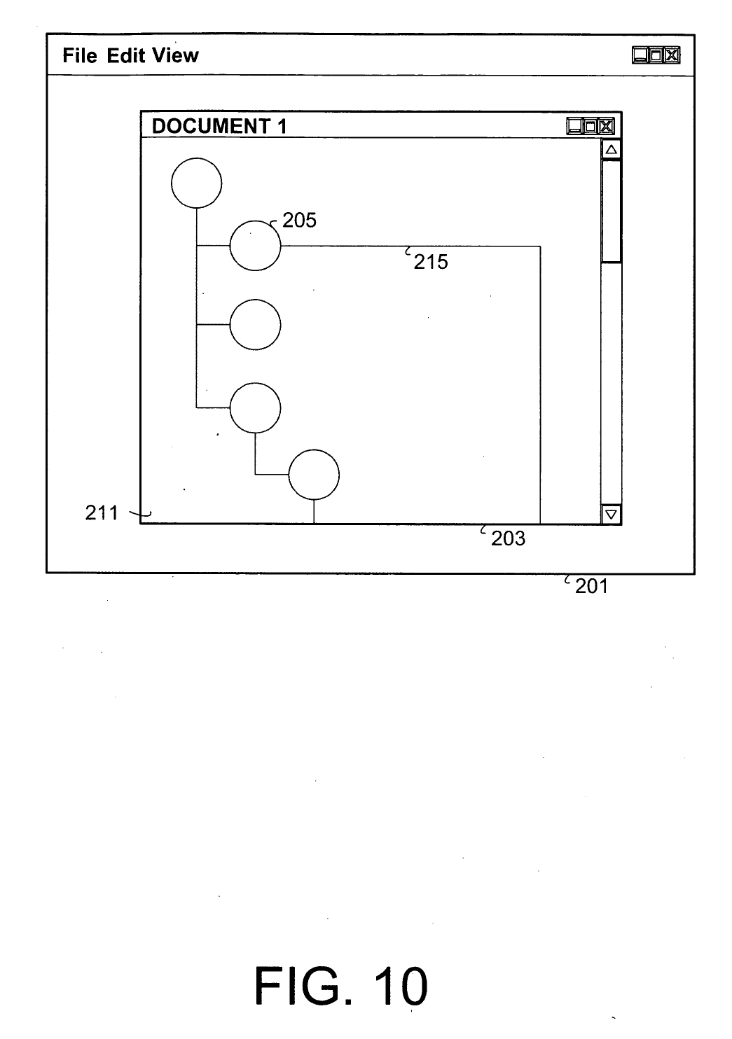

FIG. 10 illustrates an application window 201 comprising a pane 203, presenting a view 211 of a node-link structure. The view comprises a node 205 and a segment of a link 215, wherein the node 205 is related through the link 215 to another node, which is not displayed.

In one case, the node 205, and the node to which it is related may not be simultaneously displayable in within the pane 203 due to their absolute coordinates within the structure. In another case, they may be simultaneously displayable, but at the cost of reducing their contextual support and by the same token, their comprehensibility. However, in both of these cases, it would be convenient for a user to be automatically provided with two panes presenting complementary views of the structure, a first of which comprises the node 205, and the second, the node to which it is related, wherein the node 205 and the node to which it is related could be readily placed into their respective contexts.

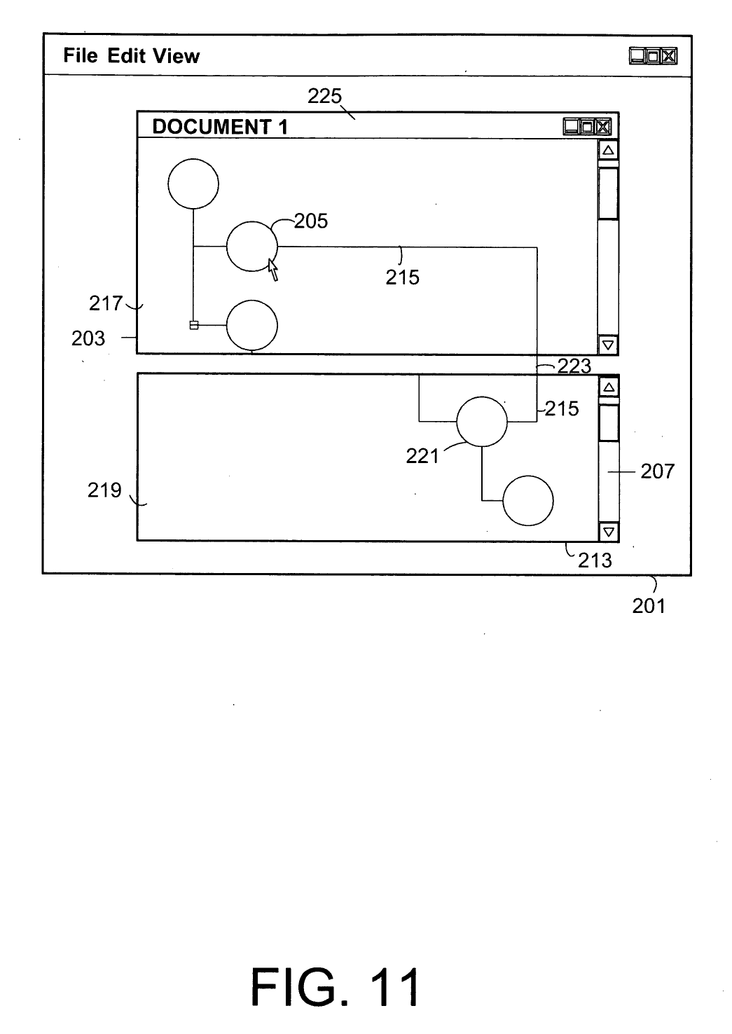

FIG. 11 illustrates the window 201 comprising the pane 203, and a pane 213, presenting different views of the structure. The pane 203 presents a view 217 comprising the node 205 and a segment of the link 215, and the pane 213 presents a view 219 comprising another segment of the link 215 and a node 221, wherein the node 205 is related to the node 221 through the link 215. There is also shown an external link 223, joining one end of the segment of the link 215 displayed in the pane 203, to that of the segment of the link 215 displayed in the pane 213.

Such a display of complementary views was achieved according to a method of the present invention, and requires a negligible amount of effort on behalf of the user. As a matter of fact, the latter is only required to select the node 205 or the link 215 from the view 217 in order for the pane 213 to be created, and the view 219 to be displayed. In the preferred embodiment, the user performs the selection by positioning a cursor on the node 205 or the link 215, and pressing a user control.

Once the node 205 or the link 215 is selected, its absolute coordinates within the structure are calculated from its display coordinates, and used to search for a corresponding node or link in lists associated to the structure.

If the absolute coordinates are found to correspond to the node 205 within the list of nodes, the list of links is searched for a link associated to the node 205, and the link 215 is identified as relating the node 205 to the node 221. Consequently, the structure is traversed through the lists of nodes and links from the node 221 in order to locate neighboring nodes and links for the purpose of defining a contextual support. However, if the absolute coordinates are found to correspond to the link 215 within the list of links, the nodes 205 and 221 are identified as being related through the link 215. Subsequently, the nodes 205 and 221 are located in the list of nodes, and their absolute coordinates are compared with those of boundary elements of the view 217. The node 205 is found to be comprised within the view 217 while the node 221 is not; consequently, the structure is traversed through the lists of nodes and links from the node 221 in order to locate neighboring nodes and links for the purpose of defining a contextual support. Finally, the pane 213 is created in order to present the view 219 comprising the node 221 and its contextual support.

In the preferred embodiment, in the case where the link 215 is initially selected, the segments of the link 215 are displayed in a different colour in order for them to be clearly identified as segments of a selected link. In the case where the node 205 is selected, the node is assigned a different colour in order for it to be clearly identified as selected.

In the case illustrated in FIG. 11, it is important to note that the node 205 is located above the node 221 in the node-link structure. As a result, and according to the preferred embodiment, the pane 213 is placed beneath the pane 203 in order to preserve the spatial configuration of the structure. Furthermore, the pane 213 is particular in that it does not comprise a toolbar such as a toolbar 225 comprised in the pane 203, in order to have the external link 223 join the end of the segment of the link 215 comprised in its view 219.

However, in other cases, the toolbar and scroll bar configuration of the panes 203 and 213 may be otherwise in order to accommodate a display of links. For instance, if the node 221 is located to the left of, and within a reasonably small vertical distance from the node 205, the pane 213 will be located to the left of the pane 203, comprise a toolbar such as the toolbar 225, and its scroll bar 207 will be located on its left-side in order to have the external link 223 join the end of the segment of the link 215 comprised in its view.

In another embodiment, no external links are displayed, and the pane 213 comprises a toolbar and a scroll bar according to the standard format.

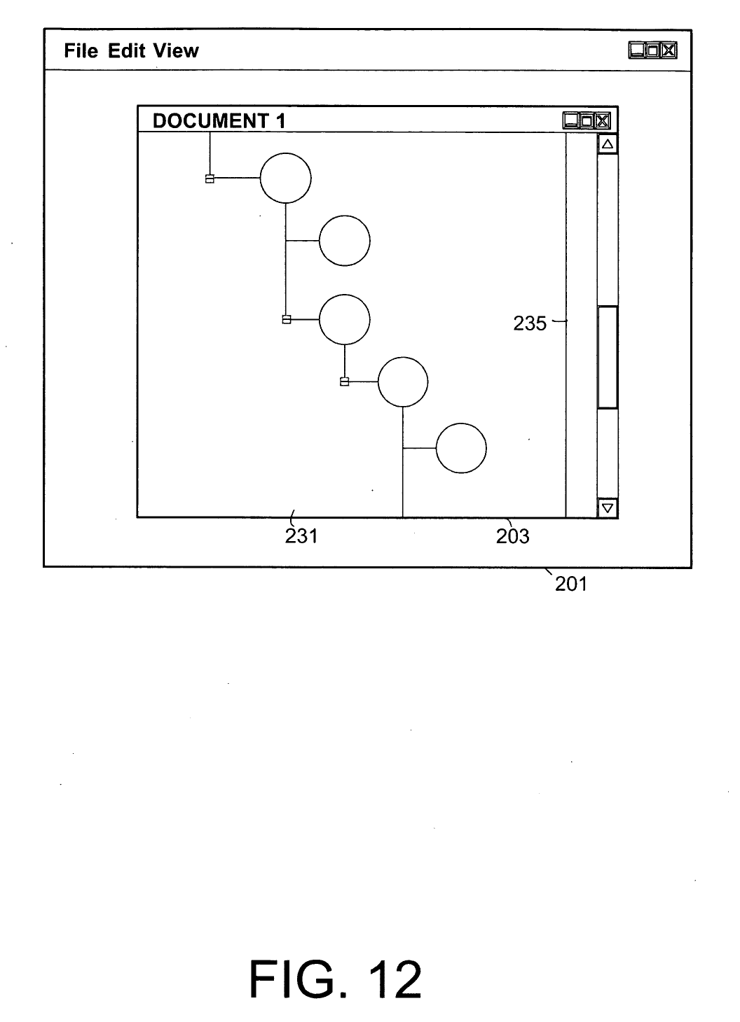

Referring now to FIG. 12, there is illustrated the application window 201 comprising the pane 203 presenting a view 231 of the structure. The view 231 comprises a segment of a link 235, which relates two nodes of the structure, wherein the two nodes are not comprised within the view 231.

The link 235 is somewhat meaningless without the nodes to which it is associated. In this case, the nodes may not be simultaneously displayed within the pane 203 due to their absolute coordinates within the structure. It would be convenient for the user to be presented with two panes presenting complementary views of the structure, each of which comprises one of the two nodes related through the link 235.

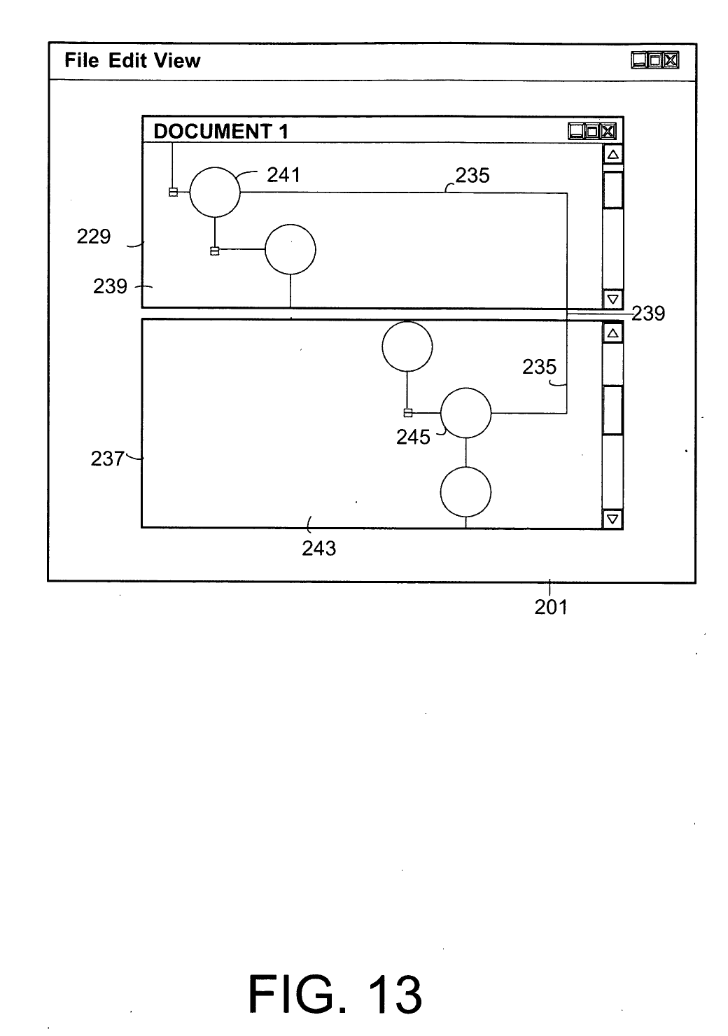

FIG. 13 illustrates the window 201 comprising panes 229 and 237, presenting different views of the structure. The pane 229 presents a view 239 comprising a node 241 associated to a segment of the link 235, and the pane 237 presents a view 243 comprising a node 245 associated to another segment of the link 235, wherein the node 241 is related to the node 245 through the link 235. There is also shown an external link 247, joining an end of the segment of the link 235 displayed in the pane 229, and displayed in the pane 237.

Such a display of complementary views was achieved according to a method of the present invention, and requires a negligible amount of effort on behalf of the user. As a matter of fact, the latter is only required to select the link 235 from the view 231 in order for the view 243 to be displayed.

Once the link 235 is selected, its absolute coordinates within the structure are calculated from its display coordinates, and used to search for a corresponding link in a list associated to the structure. Once the link is located in the list, the nodes to which it is associated are identified as the nodes 241 and 245, searched, and located in the list of nodes. The structure is subsequently traversed from the nodes 241 and 245 in order to locate neighboring nodes and links for the purpose of defining contextual supports. Finally, the view 231 of the pane 203 is replaced by the view 239 comprising the node 241, and the pane 237 is created in order to present the view 243 comprising the node 245, wherein the nodes 241 and 245 are displayed within their context.

Although the methods presented herein above have been described as providing means for merging and creating panes comprised within a same window, it should be obvious for a person skilled in the art that the same methods may be applied for merging panes comprised in different windows, and creating new panes in a window of their own.

When dealing with a plurality of panes presenting different views of a same document, it is often difficult to determine their relative position within the document due to variations in length of scroll bars associated to the panes in which they are displayed. However, it would be convenient for the user to be provided with an indication of the relative positions in order to achieve a better understanding of the spatial structure of the document being dealt with.

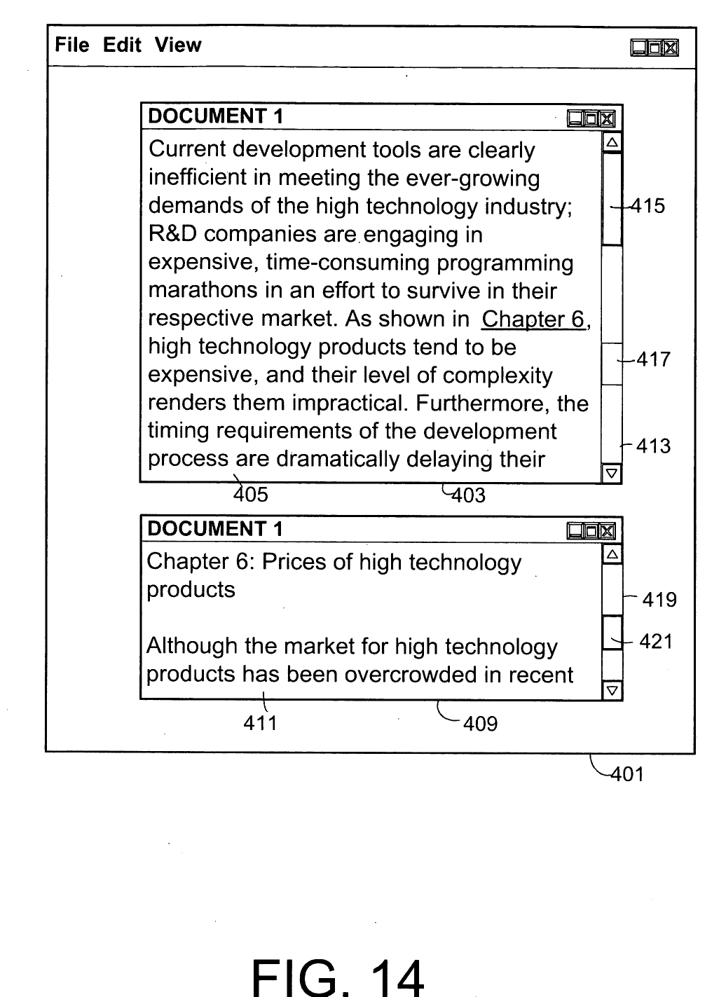

FIG. 14 illustrates an application window 401 comprising a pane 403 presenting a view 405 of a document, and a pane 409 presenting a view 411 of the same document. The pane 403 comprises a scroll bar 413, which comprises a first slider 415 indicating a position of the view 405, and a second slider 417 indicating a position of the view 411.

The relative position of the sliders 415 and 417 with respect to the ends of the scroll bar 413 indicates the relative position of the views 405 and 411 with respect to the ends of the document. However, since both sliders 415 and 417 are placed on the same scroll bar 413, they share the same reference points, namely the ends of the scroll bar 413, and consequently, the relative position of one of the two sliders with respect to the other conveys the relative position of a corresponding one of the two views with respect to the other.

The display of the additional slider 417 is achieved by first locating the position of the view 411 within the document. Subsequently, the position of a top end of the slider 417 on the scroll bar 413 is calculated according to a position of a top end of the view 411 within the document such that the position of the top end of the slider 417 relatively to the ends of the scroll bar 413 is proportional to the position of the top end of the view 411 relatively to the ends of the document. Furthermore, the position of a bottom end of the slider 417 on the scroll bar 413 is calculated according to a position of a bottom end of the view 411 within the document such that the position of the top end of the slider 417 relatively to the ends of the scroll bar 413 is proportional to the position of the top end of the view 411 relatively to the ends of the document. Finally, the slider 417 is displayed on the scroll bar 413 according to its calculated positions.

The user may also modify the position of the sliders 415 and 417 in order to modify a view presented in a corresponding one of the panes 403 and 409. When a slider is selected to be moved along the scroll bar 413, it is identified by its display coordinates. Subsequently, as the selected slider is moved, its position on the scroll bar 413 is retrieved and used to calculate a position of a corresponding view of the document, wherein the position of the view relatively to the ends of the document is proportional to the position of the selected slider relatively to the ends of the scroll bar 413.

If a position of the slider 417 is modified, a new position of the slider 419 is calculated accordingly, wherein a position of the slider 419 relatively to ends of the scroll bar 419 is proportional to the position of the slider 417 relatively to the ends of the scroll bar 413. Subsequently, the slider 419 is displayed according to its calculated position, in order for the two sliders 417 and 419 to be consistent with a view displayed in the pane 409.

In order for the user to distinguish one slider from another, each of the sliders 415 and 417 presents a distinctive graphical feature. In one embodiment they are assigned different colours. In another embodiment, the additional slider 417 is displayed as faded.

Although the invention is described in the context of two panes, it should be obvious for a person skilled in the art that the same invention may be applied in the context of more than two panes, wherein more than two sliders would be displayed within a same scroll bar.

Although some of the panes presented herein above have been described as comprising a toolbar, toolbars are not required for the methods described herein above to be applied.

It will be appreciated that the graphical elements discussed herein above are exemplary and any distinctive graphical elements may be substituted for the graphical elements discussed below without departing from the spirit of the invention.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A method of displaying a document in a graphical user interface comprising:
displaying in a scrollable manner a first part of said document;
displaying a second part of said document;
detecting an overlap between said first part and said second part of said document that results from a scrolling of the first part in response to a scroll control input; and
displaying in a scrollable manner a consolidated view of said first part and said second part of said document in response to said detecting.

2. The method of claim 1, wherein said consolidated view results from merging a display of said first part, and a display of said second part.

3. A method of displaying a document in a graphical user interface comprising:
displaying in a scrollable manner a first part of said document;
displaying a second part of said document;
detecting an overlap between said first part and said second part of said document that results from a scrolling of the first part in response to a scroll control input, wherein said first part is comprised in said second part; and
removing said second part displayed in response to said detecting.

4. The method of claims 1, 2 or 3, wherein said displaying a second part comprises displaying said second part in a scrollable manner.

5. The method of claims 1, 2, or 3, wherein said displaying in a scrollable manner comprises displaying said first part of said document in a first pane, and said displaying a second part comprises displaying said second part in a second pane.

6. A method of displaying a document in a graphical user interface, comprising:
displaying in a scrollable manner said document so as to view any one of a plurality of objects in a first part;
selecting an object of interest from said plurality in said first part;
locating a target object of said plurality related to said object of interest, and not comprised in said first part;
identifying an available display surface that does not overlap a display surface occupied by said object of interest; and
displaying said document in said available display surface so as to view a second part of said document, wherein said second part comprises at least said target object, whereby said object of interest and said target object are displayed simultaneously.

7. The method of claim 6, wherein said displaying in a scrollable manner comprises displaying said first part of said document in a first pane of an application window, and said displaying said document comprises displaying said second part of said document in a second pane of said application window.

8. The method of claim 7, further comprising reducing a dimension of said first pane, whereby a dimension of said application window is maintained.

9. The method of claim 7, further comprising reducing a dimension of said first pane to provide an adjusted first pane, whereby said dimension of said first pane is equal to a dimension of a surface occupied by said adjusted first pane and said second pane.

10. The method of claim 6, wherein said document presents a node-link structure including at least two nodes and at least one link, each of said at least one link relating at least two of said at least two nodes, said object of interest is a link of interest of said at least one link, and said target object is a target node related through said link of interest.

11. The method of claim 10, further comprising locating a second target node related through said link of interest to said first target node and not displayed in said first pane, and displaying said second target node in said first pane.

12. The method of claim 11, further comprising displaying an external link relating a segment of said link of interest displayed in said first pane and a segment of said link of interest displayed in said second pane.

13. A method of generating a representation of a position of at least two parts of a document on a scroll bar, comprising:
displaying in a first pane a first part of said document and in a second pane, a second part of said document;
displaying said scroll bar;
locating a first position of said first part in said document, and a second position of said second part in said document;
determining a first slider position according to said first position and a length of said scroll bar, and a second slider position according to said second position and said length of said scroll bar;
displaying said first slider according to said first slider position in said scroll bar; and
displaying said second slider according to said second slider position in said scroll bar.

14. The method of claim 13, further comprising determining a first slider length according to a size of said document, a size of said first part, and said length of said scroll bar, and determining a second slider length according to a size of said document, a size of said first part, and said length of said scroll bar, wherein said displaying said first slider comprises displaying said first slider according to said first slider length, and said displaying said second slider comprises displaying said second slider according to said second slider length.

15. The method of claim 13, further comprising scrolling through said document in either one of said first pane and said second pane using a corresponding one of said first slider and said second slider.

16. The method of claim 13, further comprising modifying a length of said scroll bar, determining a new first slider position, a new second slider position, a new slider first slider length, and a new second slider length according to said modifying, and displaying said first slider according to said new first slider position and said new first slider length, and said second slider according to said new second slider position and said new second slider length in said scroll bar.

17. A computer program product for displaying a document in a graphical user interface comprising a computer usable storage medium, having computer readable program code means embodied in the medium, the computer readable program code means comprising:
computer readable program code means for displaying in a scrollable manner a first part of said document;
computer readable program code means for displaying a second part of said document;
computer readable program code means for detecting an overlap between said first part and said second part of said document that results from a scrolling of the first part in response to a scroll control input; and
computer readable program code means for displaying in a scrollable manner a consolidated view of said first part and said second part of said document in response to said detecting.

18. A computer program product for displaying a document in a graphical user interface comprising a computer usable storage medium having computer readable program code means embodied in the medium, the computer readable program code means comprising:
computer readable program code means for displaying in a scrollable manner a first part of said document;
computer readable program code means for displaying a second part of said document;
computer readable program code means for detecting an overlap between said first part and said second part of said document that results from a scrolling of the first part in response to a scroll control input, wherein said first part is comprised in said second part; and
computer readable program code means for removing said second part displayed in response to said detecting.

19. A computer program product for displaying a document in a graphical user interface comprising a computer usable storage medium having computer readable program code means embodied in the medium, the computer readable program code means comprising:
computer readable program code means for displaying in a scrollable manner said document so as to view any one of a plurality of objects in a first part;
computer readable program code means for selecting an object of interest from said plurality in said first part;
computer readable program code means for locating a target object of said plurality related to said object of interest, and not comprised in said first part;
computer readable program code means for identifying an available display surface that does not overlap a display surface occupied by said object of interest; and
computer readable program code means for displaying said document in said available display surface so as to view a second part of said document, wherein said second part comprises at least said target object, whereby said object of interest and said target object are displayed simultaneously.

20. A computer program product for generating a representation of a position of at least two parts of a document on a scroll bar comprising a computer usable storage medium having computer readable program code means embodied in the medium, the computer readable program code means comprising:
computer readable program code means for displaying in a first pane a first part of said document and in a second pane, a second part of said document;
computer readable program code means for displaying said scroll bar;
computer readable program code means for locating a first position of said first part in said document, and a second position of said second part in said document;
computer readable program code means for determining a first slider position according to said first position and a length of said scroll bar, and a second slider position according to said second position and said length of said scroll bar;
computer readable program code means for displaying said first slider according to said first slider position in said scroll bar; and
computer readable program code means for displaying said second slider according to said second slider position in said scroll bar.
